(19) United States
(12) Patent Application Publication
(10) Pub. No.: US 2003/0189621 A1
(43) Pub. Date: Oct. 9, 2003

(54) Liquid discharge head and recording apparatus provided with the liquid discharge head

(75) Inventors: Hideyuki Sugioka, Kanagawa (JP); Takayuki Yagi, Kanagawa (JP); Takeo Yamazaki, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/400,481

(22) Filed: Mar. 28, 2003

(30) Foreign Application Priority Data
Apr. 4, 2002 (JP) 2002-102509

(51) Int. Cl. B41J 2/05

(52) U.S. Cl. 347/56

(57) ABSTRACT

A liquid discharge head for discharging liquid droplets utilizing generated bubbles by heating liquid to bubble comprises discharge port for discharging liquid droplets, bubbling chamber communicated with the discharge port for filling liquid; heat-generating member arranged in the bubbling chamber, being supported in a state of having gaps on both sides to the inner wall faces of the bubbling chamber; and supporting portion for supporting the heat-generating member. Then, after the generation of bubble in liquid by the heat-generating member, the surface temperature of the heat-generating member is made lower than the bubbling temperature at the time of bubble extinction by the heat radiation from the heat-generating member to the supporting portion side. In this way, it is made possible to prevent liquid from being heated again to generate bubble subsequent to the bubble extinction.

### BACKGROUND OF THE INVENTION

1. Field of the Invention

The present invention relates to a liquid discharge head that discharges liquid by the utilization of bubbles generated by heating liquid in flow paths for bubbling. The invention also relates to a recording apparatus that uses the liquid discharge head for recording information, such as images, characters, on a recording sheet, film, or some other recording medium.

Conventionally, the liquid discharge head is used for the application thereof in various fields, such as micro processing, experiment and analysis, image formation, among some others. Here, however, the description is made of the head of ink jet recording method as the example.

2. Related Background Art

The ink jet recording method, in which ink droplets are discharged for the adhesion thereof to a recording medium for recording images and the like, makes high-speed recording possible with the advantages that it performs recording in high quality with a lesser amount of noises. Further, the ink jet recording method makes it easier to record images in colors, and among many other excellent advantages, it can record on an ordinary paper, and the like. Furthermore, the entire body of the apparatus can be made compact easily.

A recording apparatus that adopts the ink jet recording method of the kind is generally provided with a recoding head having discharge ports for enabling ink to fly for discharging it as ink droplets; ink flow paths communicated with the discharge ports; energy generating means arranged for a part of each ink flow path to give ink discharge energy for discharging it. Here, for example, there have been disclosed in the specifications of Japanese Patent Publication 61-59911, Japanese Patent Publication 61-59912, Japanese Patent Publication 61-59913, and Japanese Patent Publication 61-59914, respectively, a method for discharging ink by use of electrothermal converting element as energy generating means to enable thermal energy, which is generated by the application of electric pulses, to act upon ink.

The recording method disclosed in each of the aforesaid publications is such that bubble is generated in ink with the action of thermal energy given to it, and by the force exerted by the action brought about by the abrupt expansion of such bubble, ink is discharged from each discharge port provided for the leading end of the recording head, and then, images are formed by the adhesion of ink droplets discharged to a recording medium. In accordance with this method, it is possible to arrange discharge ports of the recording head in high density so that images can be recorded at high speed in high resolution and high quality. The recording apparatus that uses this method is therefore adoptable as information output means for a copying machine, a printer, facsimile equipment, and others.

For the ink jet recording method, the electrothermal converting element that has been described above should be provided, that is, it is necessary to provide a heat-generating member for heating liquid. Then, for the conventional ink jet recording method, there has been adopted a structure in which thin resistive film is provided for the wall faces of flow path, and electrodes are electrically connected to the two side of the thin resistive film for the application of electric pulses.

However, when the thin resistive film is provided for the wall faces as described above, the thermal energy that has been generated by the thin resistive film is scattered and lost on the wall faces at a considerable ratio. As a result, efficiency is lowered in converting thermal energy into energy for bubbling use (bubbling energy), and in some cases, power dissipation becomes greater. In order to solve a problem of the kind, there has been disclosed in the specifications of Japanese Patent Application Laid-open No. 55-57477, and Japanese Patent Application Laid-open No. 62-94347 a liquid discharge head capable of reducing power dissipation by use of the heat-generating member, which is partly expanded in the air in the inner space of each flow path, thereby to prevent heat from being scattered and lost in the recording head main body or the base plate thereof so as to effectuate the effective conversion of electric energy supplied to the heat-generating member into the bubbling energy.

However, the conventional liquid discharge head, which is structured to improve the efficiency of conversion of the supplied electric energy into the bubbling energy with the heat-generating member, which is locally extended in the air in the inner space of the flow path as described above, makes it difficult to cause the heat of the heat-generating member to be scattered and lost in the base plate. Therefore, it takes time to reduce the temperature of the heat-generating member after bubbling, and there exist a drawback that the time is required more before transition is made possible to the next heating and bubbling. Under the circumstances, it is difficult for the conventional liquid discharge head to repeat liquid discharges at high frequency.

Also, likewise, the conventional liquid discharge head is structured so as to make it difficult for the heat of the heat-generating member to be scattered and lost on the base plate, there is a drawback that the surface temperature of the heat-generating member cannot be reduced sufficiently by the time the bubble generated in liquid is made extinct (hereinafter referred to as the time of bubble extinction). Thus, there is a fear that liquid is heated even after bubble extinction, thus generating bubble again.

Further, if the phenomenon that liquid is again heated after bubble extinction so that bubble is generated again (hereinafter referred to as re-boiling phenomenon) should take place, the number of cavitation shocks given to the surface of heat-generating member is increased. Thus, there is a fear that its durability is deteriorated.

Also, when the re-boiling phenomenon occurs, it increases the refilling time, which is required for filling the flow path with liquid to be used for discharge prior to bubbling. This makes it difficult to repeat liquid discharges at high frequency.

### SUMMARY OF THE INVENTION

Now, the present invention is designed with a view to solving the problems discussed above. It is an object of the invention to provide a liquid discharge head capable of suppressing the increase of time required for making transition possible to the next heating and bubbling for the heat-generating member, which is supported in a state of having gaps to both sides of the inner wall faces of a bubbling chamber, while preventing the occurrence of re-boiling phenomenon and making the power dissipation thereof smaller, and also, to provide a recording apparatus provided with such liquid discharge head.

In order to achieve the aforesaid object, the liquid discharge head of the present invention is a liquid discharge head for discharging a liquid droplet utilizing generated bubble by heating liquid to bubble, which comprises a discharge port for discharging a liquid droplet; a bubbling chamber communicated with the discharge port for filling liquid; a heat-generating member arranged in the bubbling chamber, being supported in a state of having gaps on both sides to the inner wall faces of the bubbling chamber; and supporting portion for supporting the heat-generating member. Then, for this liquid discharge head, after the bubble generation in liquid by the heat-generating member, the surface temperature of the heat-generating member is made lower than the bubbling temperature at the time of bubble extinction by the heat radiation from the heat-generating member to the supporting portion side.

With the liquid discharge head of the invention thus structured, heat is radiated from the heat-generating member to the supporting portion side subsequent to having liquid bubbled and discharged by the heat-generating member. Thus, the surface temperature of the heat-generating member is made lower than the bubbling temperature at the time of bubble extinction, and the re-boiling phenomenon at the time of bubble extinction is suppressed. Also, the liquid discharge head is arranged so that the heat-generating member is supported in a state of having gaps on both sides to the inner wall faces of the bubbling chamber where liquid is filled. In this way, it is made possible to prevent heat from being scattered and lost on the base that supports the liquid discharge head and to the head supporting portion side. The electric energy supplied to the heat-generating member is converted into bubbling energy efficiently. In this respect, as the structure that supports the heat-generating member, if only the structure can support it without closing the discharge port direction, it may be possible to support the heat-generating member either in a twin-beam fashion on in a single-beam (cantilever) fashion.

Also, the liquid discharge head of the present invention is formed to be flat by thin resistive film, and first and second electrodes for applying and electric signal to the heat-generating member are provided in positions facing each other with the heat-generating member between them, and the heat-generating member bubbles liquid in the vicinity of both faces thereof, respectively.

As described above, the liquid discharge head of the present invention generates a bubble on both faces of the flat heat-generating member. Thus, as compared with the conventional heat-generating member, which is installed on the inner wall face of the liquid discharge head, the volume of bubble is made approximately twice as much, and the discharge energy of liquid is enhanced accordingly. Also, in accordance with the liquid discharge head of the present invention, it becomes possible to obtain the same amount of discharge energy with a lesser amount of power dissipation as compared with the conventional liquid discharge head. In this respect, the shape of the heat-generating member may be the one other than the flat shape.

Also, when the flat heat-generating member is used, only the heat-generating member is heated abruptly up to a temperature at which film boiling occurs in order to generate bubbles at the same time on both faces of the heat-generating member, respectively, for example. Thus, the temperature of the heat-generating member rises more than the bubbling temperature evenly in a short period of time. Therefore, the variation of bubbling time on both faces of the heat-generating member is made smaller, and bubbles can be generated simultaneously on both faces of the heat-generating member.

Also, for the liquid discharge head of the present invention, the supporting portion is provided with the first and second electrodes, and given the distance between the first electrode and the second electrode as W₁; the heat conduction distance of the heat-generating member at the time of bubbling as d₁; and the heat conduction distance of the heat-generating member at the time of bubble extinction as d₂, the distance W₁ satisfies a condition of 2d₁<W₁<d₂. In this manner, it becomes possible to make the surface temperature at the time of bubble extinction lower than the bubbling temperature, because the heat that may escape to the supporting portion side is made smaller at the time of bubbling.

Also, it is preferable for the liquid discharge head of the present invention that liquid contains water, and the surface temperature of the heat-generating member is made 300° C. or less at the time of bubble extinction by the heat radiation from the supporting portion. In this respect, it is more preferable that the surface temperature of the heat-generating member is made 100° C. or less at the time of bubble extinction.

Also, the liquid discharge head of the present invention is formed to be a thin film-laminated element having protection films laminated on both sides of thin resistive film, and if the thickness D of the thin film-laminated element is larger than the 2 d₁ of the previous condition, the ratio of thermal energy that may escape to the supporting portion side is increased at the time of bubbling. As a result, the thermal energy, which is converted into bubbling energy, is made significantly small. This is not preferable. Therefore, the D<2 d₁ should preferably be satisfied. Also, if the thickness D is extremely small, the strength of beam portion is lowered. This is not preferable, either. Typically, therefore, in consideration of such requirements as pulse width, material of the thin film-laminated layer, and the volume of liquid droplet, the condition of the thickness D of the thin film-laminated layer element should preferably be 0.1 μm or more and 12 μm or less, and more preferably, 0.5 μm or more and 3 μm or less with respect to the aforesaid condition of the thickness D.

Also, the liquid discharge head of the present invention is provided with the heat-generating member having a bubbling region of an area S₁ on the front and rear sides, respectively; the front-rear communication path having the minimum aperture area S₂ to enable each bubbling surface on the front and rear sides of the heat-generating member to be communicated; the ink supply port having the minimum aperture area S₃; and the discharge port having the minimum aperture area S₄, and it is preferable to make arrangement so that the conditions of S₂>S₃, S₂>S₄, and S₁>S₄ are satisfied, respectively. In this way, it becomes possible to enable bubbling on the rear and front faces of the heat-generating member to contribute effectively to discharging ink droplets, and also, to enhance the utilization efficiency of energy for nozzles as a whole.

### BRIEF DESCRIPTION OF THE DRAWINGS

FIG. 1 is a plan view that shows an ink jet recording head in accordance with a first embodiment of the present invention, taken by the X-Z plane.

FIG. 2 is a cross-sectional view that shows the recording head, taken by the X-Y plane.

FIG. 3 is a cross-sectional view that shows the recording head, taken by the Y-Z plane.

FIG. 4 is a view that illustrates the relations between the distance W₁, the surface temperature of a heat-generating member at the time of bubble extinction, and the density of energy supplied to the heat-generating member.

FIG. 5 is a cross-sectional view that shows a recording head in accordance with a second embodiment of the present invention.

FIG. 6 is a view that illustrates the relations between the distance W₁, the surface temperature of a heat-generating member at the time of bubble extinction, and the efficiency of energy saving.

FIG. 7 is a cross-sectional view that shows a recording head in accordance with a third embodiment of the present invention.

### DETAILED DESCRIPTION OF THE PREFERRED EMBODIMENTS

Hereinafter, with reference to the accompanying drawings, the description will be made of the specific embodiments of ink jet recording head in accordance with the present invention.

At first, particularly among those heads that adopt ink jet recording method, the ink jet recording head (hereinafter simply referred to as recording head) of the present embodiment is provided with means for generating thermal energy as energy utilized for discharging liquid ink, and it adopts the method whereby to create the change of states of ink by the application of thermal energy. By use of this recording method, it attains to obtain characters, images, and the like, which is recorded in high density and in high precision. The present embodiment is, particularly, a BJ (Bubble Jet) head that uses heat-generating resistive element as means for generating thermal energy, and discharges ink utilizing pressure exerted by bubble generated by film boiling created by heating ink by use of this heat-generating resistive element.

(First Embodiment)

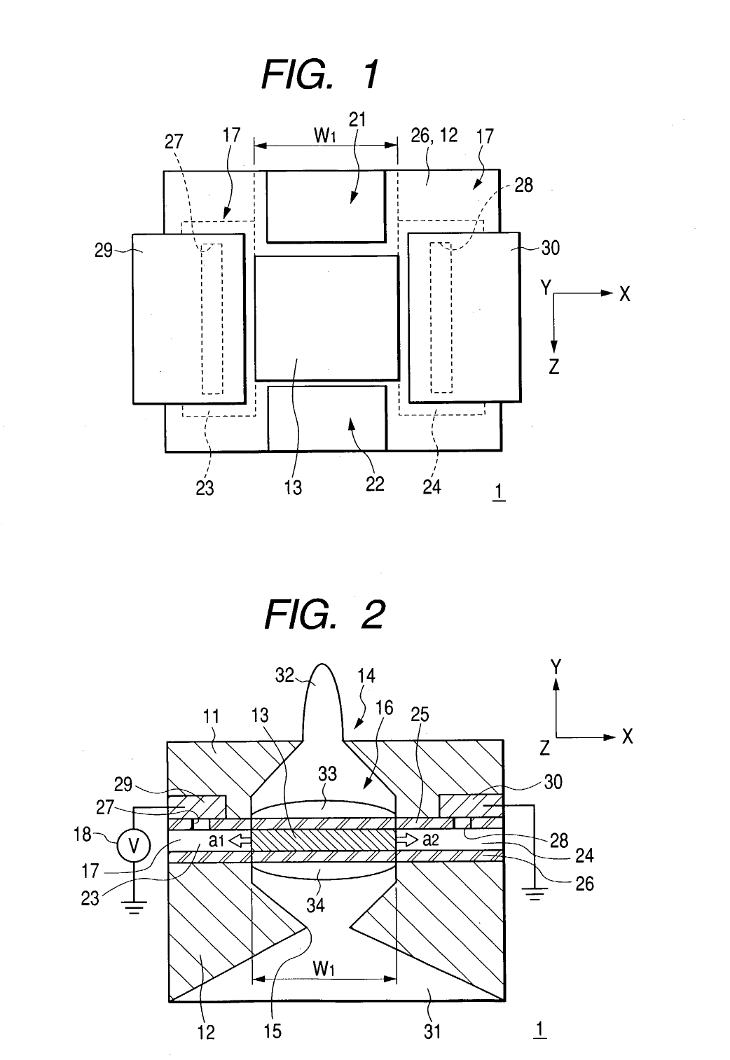

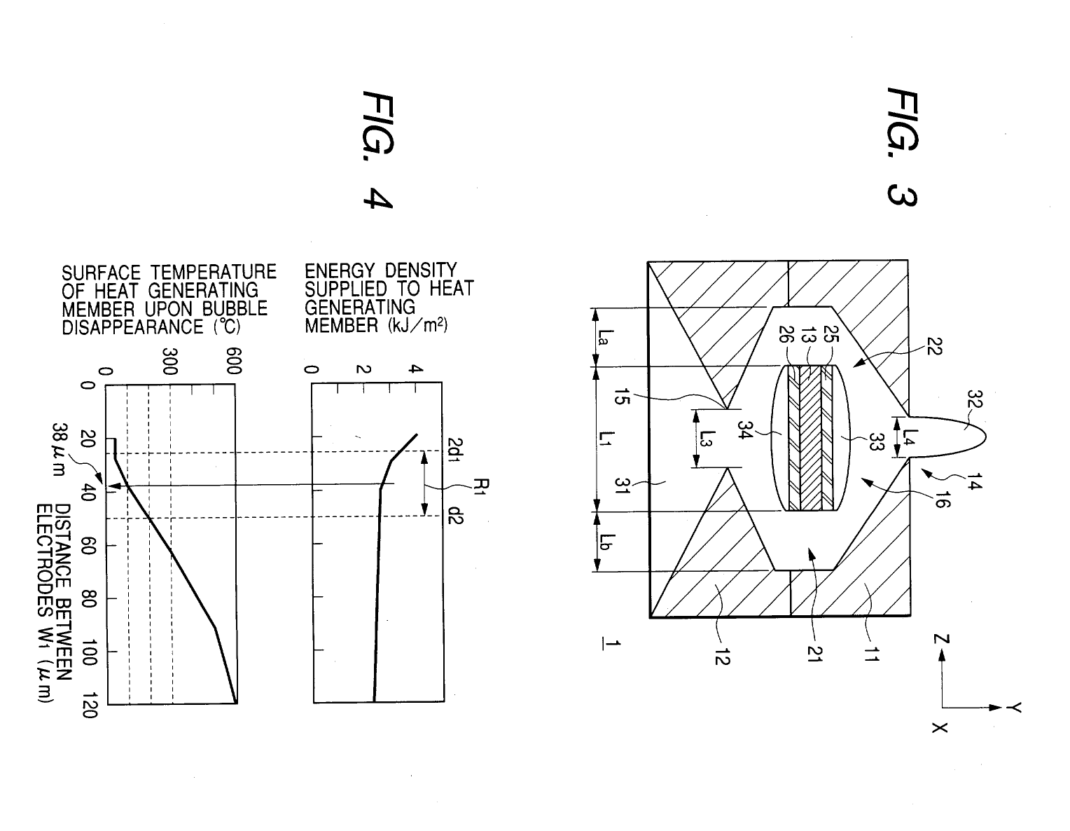

FIG. 1 is a view that sows a recording head. FIG. 2 is a cross-sectional view that shows the recording head, taken by the X-Y plane. FIG. 3 is also a cross-sectional view that shows the recording head, taken by the Y-Z plane.

In FIG. 1, FIG. 2, and FIG. 3, the recording head 1 is provided with an orifice formation member 11 having a discharge port 14 for discharging ink droplets; a base plate 12 having an ink supply port 15; and a heat-generating member 13 for heating ink to bubble. Also, the recording head 1 is provided with a bubbling chamber 16 in which ink supplied from the ink supply port 15 is filled; a supporting member 17 for supporting the heat-generating member 13 in a state where both faces thereof are arranged at a predetermined gap with respect to the inner wall faces of the bubbling chamber 16; and a driving member 18 that applies electric signals to the heat-generating member 13 in order to enable the heat-generating member 13 to give heat only for a specific period of time Δt.

The heat-generating member 13 is formed by thin resistive film to be substantially flat. The bubbling chamber 16 is laid across the orifice formation member 11 and the base plate 12, and communicated with the discharge port 14. Also, on both inner sides of the bubbling chamber 16, front-rear communication ports 21 and 22 are arranged, respectively, with the heat-generating member 13 between them in order to enable ink to flow on the front side and rear side of the heat-generating member 13 as shown in FIG. 2 and FIG. 3.

The supporting member 17 is provided with the first and second electrodes 23 and 24, which are arranged, respectively, in the positions facing each other with the heat-generating member 13 between them.

Then, on both faces of the heat-generating member 13, and the first and second electrodes 23 and 24, the insulating protection films 25 and 26 are laminated, respectively. Through the insulating protection films 25 and 26, these are laminated between the orifice formation member 11 and base plate 12. For the insulating protection films 25 and 26, contact holes 27 and 28 are provided, and through the contact holes 27 and 28, the electrical connection is made with the wiring electrodes 29 and 30 that supply electric power to the first and second electrodes 23 and 24.

Also, for the base plate 12, the ink supply path 31 is provided to supply ink into the bubbling chamber 16. To the ink supply path 31, ink is supplied from an ink supply portion (not shown).

Then, ink is supplied to the recording head 1 from the ink supply path side 31 through the ink supply port 15, thus filling ink in the bubbling chamber 16. The recording head 1 discharges ink droplet 32 from the discharge port 14 by means of bubbles 33 and 34 generated, respectively, on both sides of the heat-generating member 13 by heat given to ink by the heat-generating member 13.

In accordance with this recording head 1, heat is radiated from the heat-generating member 13 in the directions indicated by arrows a₁ and a₂ in FIG. 2 to the supporting member 17 side, respectively, subsequent to the generation of bubble in ink by the heat-generating member 13, and the surface temperature of the heat-generating member 13 is made lower than the bubbling temperature at the time of bubble extinction, thus suppressing the occurrence of the re-boiling phenomenon.

Also, with the front-rear communication paths 23 and 24, which are arranged, respectively, in the bubbling chamber 16 of the recording head 1, it is made possible to enable the bubbling on the rear side of the heat-generating member 13 to contribute to the performance of discharge. The heat-generating member 13 of this recording head 1 performs bubbling in the vicinity of both sides of the heat-generating member 13 arranged between the first electrode 23 and the second electrode 24, thus making it possible to utilize each of bubbles efficiently on both face of the front and back side of the heat-generating member 13. Therefore, as compared with the usual heat-generating member of one-side bubbling type, where bubbling is utilized only on one side, it is possible for this recording head to obtain bubbling energy approximately twice as much from the same energy supplied to the heat-generating member 13.

Also, the heat-conduction distance at the time of bubbling is generally shorter than the heat-conduction distance at the time of bubble extinction. Therefore, it is made possible for the recording head 1 to heat the bubbling surface of the heat-generating member 13 at the time of bubbling, and to radiate heat at the time of bubble extinction to the first and second electrodes 23 and 24 side, which serve as the supplying member 17, thus making the surface temperature of the heat-generating member 13 lower than the bubbling temperature at the time of bubble extinction. In this way, the occurrence of the re-boiling phenomenon can be suppressed.

Then, given the distance (width of the heat-generating member) between the first electrode 23 and the second electrode 24 as W₁; the heat conduction distance of the heat-generating member 13 at the time of bubbling as d₁; and the heat conduction distance of the heat-generating member 13 at the time of bubble extinction as d₂, the distance W₁ satisfies the following expression 1 for the recording head:

2 d₁<W₁<d₂ expression 1.

With the selection of the distance W₁ as described above, the heat that may escape in the horizontal direction to the supporting portion 17 side becomes smaller at the time of bubbling, and also, it becomes possible to make the surface temperature of the insulating protection films 25 and 26 of the heat-generating member 13 lower than the bubbling temperature at the time of bubble extinction, hence making it possible to suppress the occurrence of re-boiling phenomenon.

However, the heat conduction distance d at the time t is defined as d=2 (νt)^{0.5} where the heat diffusion ratio is ν for a single material. Also, as to the thin film lamination layer of n layer having the thickness Lⱼ, the heat diffusion ratio νⱼ, (j=1, 2, 3, . . . n), it is defined as follows:

d={L₁ 2 (ν₁t)^{0.5}+L₂ 2 (ν₂t)^{0.5}+L₃ 2 (ν₃t) ^{0.5} . . . +Lₙ 2 (νₙt)^{0.5}}/L^{total}

where the entire thickness of the film is given as L^{total}. Also, in a case of ink (liquid) the main component of which is water, the bubbling time indicates a time from the application of voltage to the heat-generating member until the surfaces of the insulating protection films 25 and 26 of the heat-generating member 13, which are in contact with ink, reach a temperature of approximately 300° C. Also, the time of bubble extinction is a time needed for the bubble, which is generated and developed on the surface of the heat-generating member 13, to be shrunken to return to the surface of the heat-generating member 13 again. This indicates a time of approximately 10 μs after bubbling.

For the recording head 1 of the first embodiment, the heat-generating member 13 is formed with a poly-silicon layer of approximately 1.0 μm thick, and the insulating protection film 25 and 26 are formed by an SiN layer of approximately 0.25 μm thick. Also, the distance W₁ (=the width of the heat-generating member 13) is approximately 38 μm, and the pulse width of electricity is set at approximately 1.0 μs. Also, the energy, which is supplied to the heat-generating member 13, is set at a value 1.2 times the threshold value needed for bubbling.

Consequently, the heat dispersion ratio of the heat-generating member 13 is 89.1×10⁻⁶ m²/s. The heat dispersion ratio of the insulating protection film 25 and 26 is 0.909×10⁻⁶ m²/s. Here, 2 d₁=24.5 μm and d₂=50.4 μm. Therefore, it is desirable to select the distance W₁ within a range of 24.5 μm<W₁<50.4 μm.

FIG. 4 is a view that shows the density of energy supplied to the heat-generating member 13 when applying voltage equivalent to the voltage, which is 1.2 times the threshold bubbling voltage, and the dependability of the surface temperature of the heat-generating member 13 at the time of bubble extinction with respect to the distance W₁ across the electrodes. In FIG. 4, the range R₁ indicates the range of 2 d₁<W₁<d₂. With the distance W₁ being set to satisfy such condition, a higher efficiency higher than that of the conventional heat-generating member can be secured, because it is made possible then to control the efficiency not to be lowered by heat escape to the supporting portion 17 side, while reducing the surface temperature of the heat-generating member 13 at the time of bubble extinction. In this way, the occurrence of re-boiling phenomenon can be suppressed.

Also, as shown in FIG. 4, the density of energy supplied to the heat-generating member 13 with respect to the distance W₁, and the dependability of the surface temperature of the heat-generating member 13 at the time of bubble extinction are obtained so as to set the distance W₁ that makes the surface temperature of the heat-generating member 13 at the time of bubble extinction lower than the bubbling temperature of ink, hence making it possible to suppress the occurrence of re-boiling phenomenon. Particularly, when ink contains water, the bubbling temperature is approximately 300° C. In other words, the occurrence of re-boiling phenomenon can be suppressed by making the surface temperature of the heat-generating member 13 300° C. or less, more preferably, 200° C. or less at the time of bubble extinction due to the contents of water in ink and heat radiation from the supporting portion 17.

Also, if the surface temperature of the heat-generating member 13 is made almost 100° C. or less at the time of bubble extinction by the heat radiation from the supporting portion 17, it becomes less than the water evaporation temperature in the equilibrium state. The effect of the re-boiling phenomenon suppression is increased. However, if the amount of lateral heat radiation should be increased more than necessary, there is a need for increasing the supply of energy as shown in FIG. 3. Here, the heat radiation is made from the supporting portion 17, and the surface temperature of the heat-generating member 13 is made almost 100° C. at the time of bubble extinction. In this way, the occurrence of re-boiling phenomenon is suppressed, while it is made possible to provide a recording head having a high efficiency of energy utilization.

Also, in accordance with the first embodiment, the heat-generating member 13 of the recording head 1 is the thin film-laminated element having the insulating protection films 25 and 26 arranged for both faces of the thin resistive film. If the thickness D of the thin-film-laminated element is as large a value as two times the heat conduction distance d₁ at the time of bubbling of the heat-generating member 13, the ratio of thermal energy escaping to the supporting portion 17 side is increased at the time of bubbling. This is not preferable because the thermal energy that should be converted into bubbling energy is considerably reduced. Therefore, it is preferable to satisfy the condition of D<2 d₁. Also, if the thickness D of the thin film-laminated element is extremely small, the strength of the beam portion is lowered. Therefore, it is not preferable. Under the circumstances, in consideration of the pulse width, the material of the thin film-laminated element, and the volume of an ink droplet, among some others, the aforesaid condition of the width D of the thin film-laminated element is typically 0.1 μm or more and 12 μm or less, more preferably, 0.5 μm or more and 3 μm or less.

Here, the thin film-laminated element that forms the heat-generating member 13 is structured by the insulating protection films 25 and 26 formed by an SiN film of 0.25 μm thick, and a poly-silicon thin resistive film layer formed in a film thickness of 1.0 μm. Therefore, the thickness of the heat-generating member 13 in the form of thin film-laminated type is 1.5 μm. As has been described above, with the thickness of the heat-generating member 13 of thin film-laminated type being made 0.1 μm or more and 12 μm or less, more preferably, 0.5 μm or more and 3 μm or less approximately, the thermal energy generated in the heat-generating member 13 contributes to bubbling on the front and rear sides of the heat-generating member 13, thus enhancing the utilization efficiency of energy.

Also, for the recording head 1 of the first embodiment, the distance W₁ is set at 50 μm or less. With the distance W₁ being made narrower approximately to 50 μm or less, the positive heat radiation is made possible in the side direction, that is, the directions indicated by the arrows a₁ and a₂, hence suppressing the re-boiling phenomenon.

As shown in FIG. 4, given the length of the heat-generating member 13 of the recording head 1, which is orthogonal to the distance W₁, as L₁; the distance between the inner wall faces that face each of the side ends in the direction of the length L₁ of the heat-generating member 13 as La and Lb; the aperture dimension of the ink supply port 15, which is parallel to the direction of the length L₁ of the heat-generating member 13, as L₃; and the aperture dimension of the discharge port 14, which is parallel to the direction of the length L₁ of the heat-generating member 13, as L₄, it is arranged to set L₁=38 μm, La=Lb=20 μm, L₃=20 μm, and L₄=20 μm. The aperture of the discharge port 14 is configured to be a square of L₄×L₄.

In other words, the recording head 1 is provided with the heat-generating member 13 (insulating protection films 25 and 26 are laminated on both faces), which is formed by the thin resistive film having the bubbling region of an area S₁=W₁×L₁, respectively, on the front and rear sides; the front-rear communication paths 23 and 24 having the minimum aperture area of S₂=W₁×(La+Lb), which are communicated with the front and rear bubbling surfaces of the heat-generating member 13; the ink supply port 15 (narrowed portion) having the minimum aperture volume of S₃=W₁×L₃; and the discharge port 14 having the minimum aperture area of S₄=W₄×L₄. Then, the S₁=W₁×L₁=1444 μm², the S₂=W₁×(La+Lb)=1520 μm², the S₃=W₁×L₃=760 μm², and the S₄=L₄×L₄=400 μm². Each of them satisfies the condition of S₂>S₃, S₂>S₄, and S₁>S₄.

In other words, the recording head 1 is provided with the heat-generating member 13 having the bubbling region of the area S₁ on the front and rear sides thereof, respectively; the front-rear communication paths 21 and 22 having the minimum aperture area S₂, which are communicated with the front and rear bubbling surfaces of the heat-generating member 13; the ink supply port 15 of the minimum aperture area S₃; and the discharge port 14 of the minimum aperture volume S₄, and satisfies the condition of S₂>S₃, S₂>S₄, and S₁>S₄, respectively. In this way, the recording head makes it possible to enable the bubbling on the rear side of the heat-generating member 13 to contribute to effectively discharging ink droplets, thus materializing the recording head having a high efficiency of energy utilization by the nozzles as a whole.

Next, the description will be made of the principle of liquid discharge of the recording head in accordance with the present embodiment. In a state where the bubbling chamber 15 is filled with ink, pulse voltage is applied by the driving unit 18 to the heat-generating member 13 so as to raise the temperature of the heat-generating member 13 abruptly up to a temperature (300° C. or more) at which film boiling occurs. In this way, bubbles 21 and 22 are generated at the same time on both bubbling surfaces of the heat-generating member 13. Thus, abrupt expansion begins. Further, the bubbles continue to expand and push ink to the discharge port 14 side. When the bubbles continue to expand further, an independent ink droplet is formed, and then, the recording head 1 discharges the ink droplet from the discharge port 14. After that, the ink, which remains in the bubbling chamber 15 without being drawn into the ink droplet, joins ink in the ink supply path 31, thus returning to the initial condition.

Also, for the recording head 1, ink of 2.0 cps viscosity (20° C.) is supplied into the bubbling chamber 15 for discharging, for example. Here, ink is prepared in such a manner that each of compound components, such as 3.0 weight % of C.I food black, 15.0 weight % of diethylene glycol, 5.0 weight % of N-metyl-2-pyrolidone, 77.0 weight % of ion exchange water, is agitated in a mixing container and filtrated by use of a polyethylene fluoride textile filter of 0.45 μm hole diameter after evenly mixed and dissolved.

(Second Embodiment)

Next, with reference to the accompanying drawings, the description will be made of the recording head, which is provided with another heat-generating member in accordance with a second embodiment of the present invention. FIG. 5 is a cross-sectional view that shows the recording head in accordance with the second embodiment, taken by the X-Y plane. The fundamental structure of the recording head of the second embodiment is the same as that of the recording head-described above with the exception of the heat-generating member. Therefore, the same reference marks are applied to the same members, and the description thereof will be omitted.

As shown in FIG. 5, in accordance with the second embodiment, the supporting portion 57 supports the heat-generating member 51 of the recording head 2, and all other structures are substantially the same as those of the recording head 1 of the first embodiment with the exception of the film thickness of the heat-generating member 51, which is formed to be smaller than that of the insulating protection films 25 and 26.

In accordance with the second embodiment, the film thickness of poly-silicon film that serves as the thin resistive film to form the heat-generating member 51 of the recording head 2 is approximately 0.1 μm, and smaller than the film thickness of 0.25 μm of the SiN insulating protection films 25 and 26. Also, the distance W₁ is set at 18 μm.

In accordance with the second embodiment, the film thickness of the heat-generating member 51 formed by thin resistive film is set to be smaller than that of the insulating protection films 25 and 26, hence minimizing the inner thermal energy of the heat-generating member 51, which can hardly be utilized. In this way, the energy utilization efficiency can be enhanced. Also, it becomes possible to make the thickness of the thin film-laminated layer type heat-generating member smaller as a whole. Therefore, the thermal energy generated inside the heat-generating member can be utilized more for bubbling on the front and rear sides.

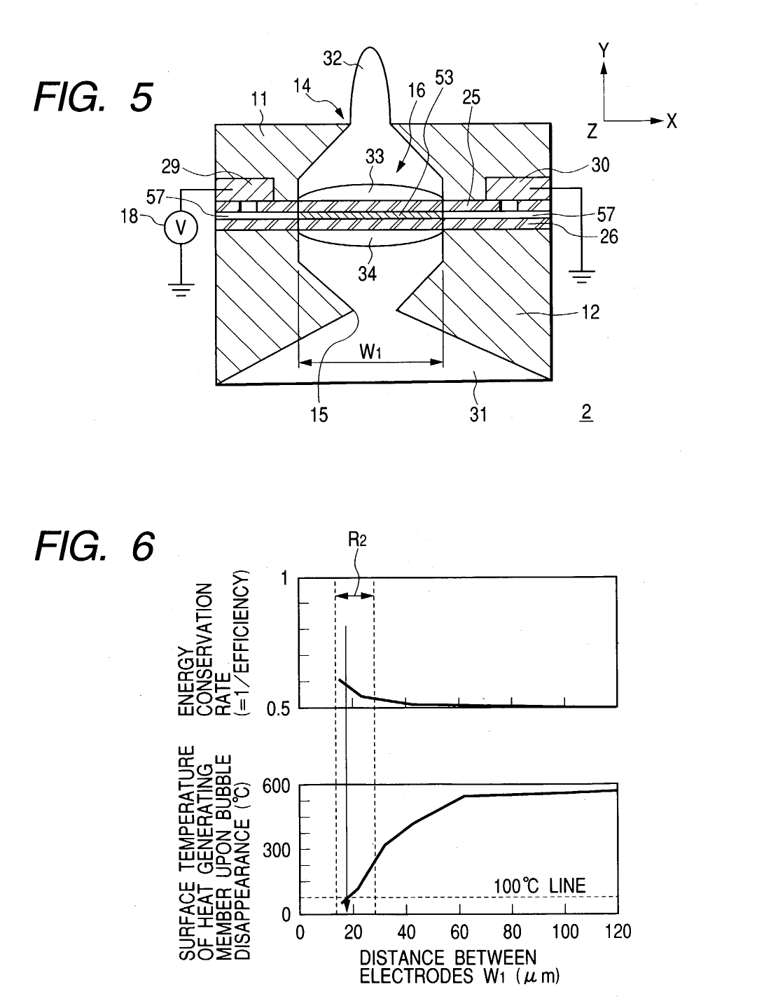

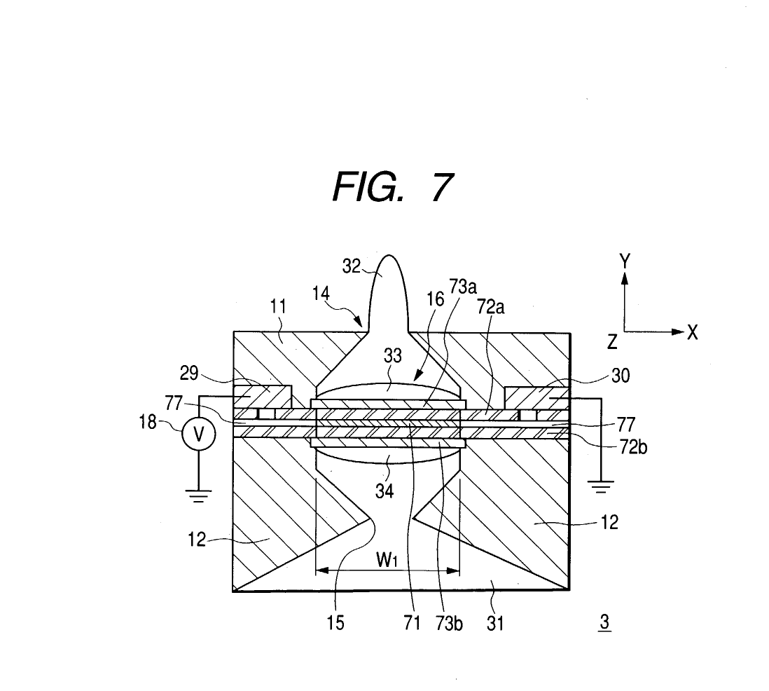

FIG. 6 is a view that shows the ratio between energy supplied to the heat-generating member 51 of the present embodiment, and energy supplied to the heat-generating member of one-side bubbling type (=energy saving ratio), as well as the dependability of the surface temperature of the heat-generating member 51 at the time of bubble extinction with respect to the distance W₁ when applying the voltage equivalent to a voltage 1.2 times the bubbling threshold voltage.

The range R₂ shown in FIG. 6 indicates a range of 2d₁<W₁<d₂. More specifically, this range R₂ indicates a range of 12.7 μm<W₁<25.8 μm. Then, the distance W₁ that satisfies this condition is set at W₁=18 μm (a square heat-generating member 51 of 18×18 μm), for example, it becomes possible to make the energy saving ratio=0.6 (energy consumption can be curtailed by 40%), and also, make the surface temperature of the heat-generating member 51 approximately 100° C. at the time of bubble extinction. Then, in accordance with the recording head 2, the reduction of efficiency, which is caused by heat escape to the supporting portion 57 side can be suppressed, thus securing a higher efficiency than that of the conventional heat-generating member, while lowering the surface temperature of the heat-generating member 51 at the time of bubble extinction. In this way, the re-boiling phenomenon can be suppressed.

(Third Embodiment)

Further, with reference to the accompanying drawings, the description will be made of a recording head provided with another heat-generating member in accordance with a third embodiment of the present invention. FIG. 7 is a cross-sectional view that shows the recording head in accordance with the third ebodiment, taken by the X-Y plane. The fundamental structure of the recording head of the third embodiment is the same as that of the recording head described above with the exception of the heat-generating member. Therefore, the same reference marks are applied to the same members, and the description thereof will be omitted.

As shown in FIG. 7, in accordance with the third embodiment, the supporting portion 77 supports the heat-generating member 71 of the recording head 3, and metal protection films 73a and 73b for use of cavitation proof, which are formed by thin metallic film, are laminated on the insulating protection films 72a and 72b. All other structures of this recording head 3 are substantially the same as those of the recording head 1 of the first embodiment with the exception of the arrangement that the surface temperature of the heat-generating member 71 is lowered by the heat radiation from the metal protection films 73a and 73b to the supporting portion 77 side.

For the recording head 3 of the second embodiment, the heat-generating member 71 is formed by TaN thin resistive film prepared in a film thickness of 0.05 μm; the insulating protection films 72a and 72b are formed by SiN film prepared in a film thickness of 0.3 μm; and the metal protection films 73a and 73b for use of cavitation proof are formed by Ta thin film prepared in a film thickness of 0.25 μm. Also, the distance W₁ is set at 20 μm. In accordance with the third embodiment, heat is radiated to the supporting portion 77 side from the metal protection films 73a and 73b for use of cavitation proof laminated on the insulating protection films 72a and 72b in order to lower the surface temperature of the heat-generating member 71 at the time of bubble extinction, hence making it possible to perform the heat radiation positively for the suppression of the re-boiling phenomenon.

For the recording head 3 of the third embodiment, the condition of 2 d₁<W₁<d₂ is specifically set to be 9.5 μm<W₁<21.8 μm. Then, the distance W₁ that satisfies this condition is set at W₁=20 μm, thus making it possible to suppress the reduction of efficiency caused by heat escape to the supporting portion 77 side, and to lower the surface temperature of the heat-generating member 71 at the time of bubble extinction, while securing a higher efficiency than that of the conventional heat-generating member. In this way, the occurrence of re-boiling phenomenon can be suppressed.

In this respect, the aforesaid recording head allows the generated bubble to be communicated with the air outside in the vicinity of the discharge port, and the volume of the discharging ink droplets is made constant to stabilize the discharging characteristics of ink droplets. In order to enable the bubble and the air outside to be communicated, the distance between the heat-generating member and the discharge port is made smaller or the volume of bubble is made larger by the application of larger driving voltage, among some other methods applicable, for example.

Also, although not shown, a recording apparatus that uses the aforesaid recording head for recording images or the like on a recording medium, such as a recording sheet, makes it possible to perform high-speed recording with the provision of plural recording heads, and, further, to perform recording stably with the provision of signal supplying portion that supplies electric signals for generating film boiling by each of the heat-generating members of the recording head. Also, the recording apparatus of the kind makes it possible to materialize high-quality recording in high resolution at high speed by discharging ink droplets by use of the aforesaid plural recording heads.

Also, for the embodiments of the present invention described above, it is of course possible to modify arbitrarily the dimensions, materials, driving conditions, and others as design items for the base plate, orifice formation member, bubbling chamber, heat-generating member, discharge port, and the like.

What is claimed is:

1. A liquid discharge head for discharging a liquid droplet utilizing generated bubbles by heating liquid to bubble comprising:
a discharge port for discharging liquid droplet;
a bubbling chamber communicated with said discharge port for filling liquid;
a heat-generating member arranged in said bubbling chamber, being supported in a state of having gaps on both sides to the inner wall faces of said bubbling chamber; and
a supporting portion for supporting said heat-generating member, wherein
after bubble is generated in liquid by said heat-generating member, the surface temperature of said heat-generating member is made lower than the bubbling temperature at the time of bubble extinction by the heat radiation from said heat-generating member to said supporting portion side.

2. A liquid discharge head according to claim 1, wherein said heat-generating member is formed to be flat by a thin resistive film;
for said supporting portion, first and second electrodes for applying a electric signal to said heat-generating member are provided in a position facing each other with said heat-generating member between them; and
liquid is bubbled, respectively, in the vicinity of both faces of said heat-generating member.

3. A liquid discharge head according to claim 2, wherein said supporting portion is provided with said first and second electrodes, and given the distance between said first electrode and the second electrode as W₁, the heat conduction distance of said heat-generating member at the time of bubbling as d₁, and the heat conduction distance of said heat-generating member at the time of bubble extinction as d₂, said distance W₁ satisfies a condition of 2 d₁<W₁<d₂.

4. A liquid discharge head according to any one of claim 1 to claim 3, wherein said liquid contains water, and the surface temperature of said heat-generating member is made 300° C. or less at the time of bubble extinction by the heat radiation from said supporting portion.

5. A liquid discharge head according to claim 4, wherein the surface temperature of said heat-generating member is made almost 100° C. at the time of bubble extinction by the heat radiation from said supporting portion.

6. A liquid discharge head according to claim 1, wherein said heat-generating member is formed to be a thin film-laminated element having protection films laminated on both sides of thin resistive film, and the thickness of said thin film-laminated element is 0.1 μm or more and 12 μm or less.

7. A liquid discharge head according to claim 2, wherein the distance W₁ between said first electrode and said second electrode is 50 μm or less.

8. A liquid discharge head according to claim 2, wherein said liquid discharge head is provided with the heat-generating member having a bubbling region of an area S₁ on the front and rear sides, respectively; the front-rear communication path having the minimum aperture area S₂ to enable each bubbling surface on the front and rear sides of said heat-generating member to be communicated; the ink supply port having the minimum aperture area S₃; and the discharge port having the minimum aperture area S₄, and the conditions of S₂>S₃, S₂>S₄, and S₁>S₄ are satisfied, respectively.

9. A liquid discharge head according to claim 6, wherein for said heat-generating member, the film thickness of said thin resistive film is smaller than that of said protection film.

10. A liquid discharge head according to claim 6, wherein said protection film is provided with a thin metallic film for use of cavitation proof, and the surface temperature of the heat-generating member is lowered at the time of bubble extinction by the heat radiation from said thin metallic film to said supporting portion.

11. A liquid discharge head according to claim 1, wherein said heat-generating member forms a thin film-laminated element having protection film laminated on both sides of said thin resistive film, and given the thickness of said thin film-laminated element as D, the heat conduction distance of said heat-generating member at the time of bubbling as d₁, a condition of D<2 d₁ is satisfied.

12. A recording apparatus for recording information on a recording medium by use of a liquid discharge head according to claim 1.
